(19) United States
(12) Patent Application Publication
(10) Pub. No.: US 2010/0279887 A1
(43) Pub. Date: Nov. 4, 2010

(54) NONLINEAR MAGNETOPHORETIC SEPARATION OF BIOLOGICAL SUBSTANCES

(76) Inventors: Gil U. Lee, Dublin (IE); Benjamin Yellen, Cary, NC (US); Randall Morgan Erb, Durham, NC (US)

Correspondence Address: James Meadows;Medicus Associates, 4025 Arbor Rd, Joplin, MO, 64804, US

(21) Appl. No.: 12/452,031

(22) PCT Filed: Jun. 14, 2008
(86) PCT No.: PCT/US08/07429

§ 371 Date: Apr. 27, 2010

Related U.S. Application Data
(60) Provisional application No. 60/934,683, filed on Jun. 15, 2007.

(51) Int. Cl. C40B 30/04; C40B 40/18

(52) U.S. Cl. 506/9; 506/22

(57) ABSTRACT

A method of separating a target biological analyte from a mixture of substances in a fluid sample employs nonlinear magnetophoresis. Magnetic particles having the capacity to bind to the target analyte are contacted with the fluid sample so that the analyte is immobilized on the surface of at least some of the particles. The magnetic particles are provided adjacent an array of micromagnets patterned on a substrate so that the particles are attracted the micromagnets. The magnetic particles are then subjected to a traveling magnetic field operating at or above a frequency effective to sweep those particles not bound to analyte to an adjacent micromagnet. Those magnetic particles bound to analyte have a larger size or smaller magnetic moment that prevents them from being moved to adjacent micromagnets, thereby affording separation of the analyte.

### CROSS-REFERENCE TO RELATED APPLICATION

This application claims the benefit of priority of U.S. Provisional Application No. 60/934,683, filed Jun. 15, 2007, the disclosure of which is incorporated herein by reference.

### FIELD OF THE INVENTION

The present invention relates generally to methods and materials for biological separation, and more particularly to nonlinear magnetophoretic separation for the detection and purification of biological materials in complex environments.

### BACKGROUND OF THE INVENTION

Living organisms are composed of a large number of macromolecules that are assembled from a much smaller number of building blocks. One of the key advances in cellular and molecular biology has been the development of separation techniques that are capable of identifying specific biological macromolecules. Separation technologies are now being widely used for analytical and purification purposes in biological research, biomedical technology, and large scale biochemical production.

Bioseparation technologies are based on using one or more physical or chemical properties of biological macromolecules to modify their relative position. Properties that have been used to separate biological macromolecules include density, size, hydrophobicity, net charge, and specific surface chemical groups. Bioseparation techniques commonly used in laboratories include centrifugation, liquid chromatography, and gel electrophoresis. In each of these techniques the position of the macromolecule of interest is modified in relationship to a moving phase or a stationary phase. For example, centrifugation can be used to crudely separate cellular components based on their relative density if a stationary density profile is set-up in the centrifuge tube. In liquid chromatography a sample is passed over a packed column of particles that has a defined surface chemistry or porosity. This allows specific constituents to be retained on the chromatography column based on their surface chemistry or size, respectively. In gel electrophoresis, the relative charge-to-mass ratio of biological macromolecules is used to separate them in the presence of an applied electric field based their mobility through the gel in one or two dimensions. These separation techniques are widely used to measure the presence of a biological macromolecule and/or isolate it from a complex mixture of macromolecules.

The separation technique selected to isolate a macromolecule is determined by the physical properties of the molecule of interest, the resolution of the separation to be performed, the scale at which the separation will be performed, and the availability of special reagents, such as antibodies, which make affinity separation possible. In general, biological separations need to be high resolution, which means that they are typically rather slow (i.e., most bioseparations take hours) and can only be performed on relatively small volumes (i.e., most bioseparations are performed on 1-1000 ml volume samples). This has made the development of rapid high resolution and volume separation technologies a subject of significant practical importance.

The initial clinical symptoms of many pathogen infections are nonspecific and thus difficult to treat effectively. There is a need for diagnostic tools that are highly sensitive, specific, inexpensive, easy to use, and located in primary care settings, to allow physicians to deal with such infections effectively. Sensitive affinity, catalytic, and PCR detection schemes are currently available, but these technologies are limited in use by the fact that pathogens typically must be detected in very complex environments—many potential pathogens exist, and some can be lethal at even single organism levels.

Superparamagnetic microparticles have been proposed for affinity separation as a substitute for the traditional separation column. In this process, magnetic particles are coated with a specific molecular receptor (e.g., antibodies) and reacted with the analyte in a medium that can be a complex mixture, such as cells or cell lysates. They are concentrated in a specific area of the reaction vessel using a strong permanent magnet, rinsed several times and exposed to a buffer that drives the release of the analyte (e.g., weak acid or chaotropic agent). Paramagnetic particle separation has at least three advantages over adsorption columns: i) the particles can be dispersed in the separation media which increases the rate of mass transfer; ii) the separation can be performed in complex mixtures, e.g., cell culture media or whole blood; and iii) relatively small amounts of magnetic particles can be used which makes it easier to extract the analyte from the paramagnetic particles. However, improvements to paramagnetic particle separation could take the form of permitting separation based on particle size and/or magnetic moment, as well as separation of analyte-containing particles from those not bound to analyte. It is an object of the present invention to provide such a method and system for separating magnetic particle-bound analytes by size and/or moment.

Selected Patents and Publications: U.S. Pat. No. 6,294,342 (issued to Rohr et al.) proposes a method for assaying the presence or amount of an analyte in a sample by employing a magnetically responsive reagent and measuring its response to a magnetic field. U.S. Pat. No. 5,236,824 (issued to Fujiwara et al.) proposes a laser magnetic immunoassay (LMIA) that affords magnetophoretic light scattering by magnetically labeled analyte. U.S. Pat. No. 4,230,685 (issued to Senyei et al.) proposes magnetic separation of analyte employing microspheres coated with Protein A. U.S. Pat. No. 4,910,148 (issued to Sorenson et al.) proposes a method of separating cancer cells from a biological fluid by coating them with magnetizable particles. U.S. Pat. No. 5,466,574 (issued to Liberti et al.) proposes a method of separating magnetically labeled substances employing an arrangement of magnets for causing magnetic particles coated with analyte receptor to adhere to selected locations on the interior wall of a container. U.S. Pat. Pub. 2002/0076825 (Cheng et al.) proposes a biochip system for processing and analyzing samples wherein sample components are moved from one area of a chip to another area of a chip by traveling wave magnetophoresis. U.S. Pat. Pub. 2004/0086885 (Lee et al.) proposes a method for detecting biological materials in a sample using a magnetic transducer comprising a binding agent and superparamagnetic nanoparticles containing Fe and Au atoms. M. Lewin et al., Nat. Biotechnol., 18:410-4 (2000) describe a method for identifying stem cells by employing peptide-labeled paramagnetic nanoparticles. B. Yellen et al., PNAS, 102:8860-4 (2005) describe a method of manipulating nonmagnetic materials, e.g., colloids and cells, using a fluid dispersion of magnetic nanoparticles. C. Liu et al., Appl. Phys. Lett., 90: 184109 (2007) describe a microdevice for transporting magnetic particles that employs an external magnetic field and a series of conductors operating in alternating current mode with the object of avoiding contact and nonspecific adhesion between particles and the device. The pertinent disclosures of the aforementioned references are incorporated herein by reference.

### SUMMARY OF THE INVENTION

The present invention contemplates a method for separating at least one biological substance from a mixture of biological substances in a fluid sample. The method entails contacting a plurality of magnetic microparticles with the mixture of biological substances under conditions effective to immobilize at least one of the biological substances, e.g., a virus or bacterium, on at least one of the magnetic microparticles. The plurality of microparticles, at least some of which are bound to a biological substance, are provided adjacent a plurality of micromagnets provided on a substrate, and an external traveling magnetic field is applied thereto. The magnetic microparticles are translated over the surface of the substrate under the dual influences of the traveling magnetic field and the fixed micromagnets. Those microparticles bound to biological substance typically have larger size and lower magnetic moment, which retards their movement over the substrate. By repeated applications of the external traveling magnetic field, the microparticles are sorted by size and/or magnetic moment, which permits isolation of those microparticles bound to biological substance. The foregoing separation technique is referred to herein as “nonlinear magnetophoresis”.

In a method of the present invention, at low frequencies of the traveling magnetic field, the magnetic microparticles (beads) are shuttled between adjacent micromagnets at a rate proportional to the frequency of rotation of the external field. At higher frequencies, the onset of non-linearities in the bead's transport behavior is observed, leading to the identification of certain critical frequencies above which a specific population of beads no longer moves. This critical frequency is found to be proportional to a bead's magnetic moment and inversely proportional to its hydrodynamic drag factor. By exploiting the frequency dependence, highly sensitive separation of magnetic beads is demonstrated based on fractional differences in bead diameter and/or the specific attachment to B. globigii or S. cerevisiae. An ability to tune the external driving frequency to cause the migration velocities for different bead types to differ by several orders of magnitude is also demonstrated.

The present invention can be employed to separate macromolecules, e.g., DNA, RNA, polypeptides, proteins, and antibodies, as well as cells, e.g., stem cells, erythrocytes and white blood cells, and pathogens, e.g., viruses, bacteria, fungal spores. The invention affords many analytical and medical applications as discussed further hereinbelow.

### BRIEF DESCRIPTION OF THE DRAWINGS

FIG. 1 shows different detectable configurations that can form between analyte and two magnetic particles (Panel A), analyte, magnetic particle and fluorescent particle (Panel B), and analyte and single magnetic particle (Panel C).

FIG. 2 is a schematic of a fluidic network used to react magnetic particles with pathogens in a sample, perform a bulk separation, and introduce the magnetic particles into the magnetophoretic separator. EM—electromagnet and MS—magnetophoretic separator.

FIG. 3 shows a sequence of steps used to move a superparamagnetic microparticle carrying a B. globigii spore across the micromagnet array. Top row: Reflected light top view images of the surface of the micromagnet array in which a 1 micron superparamagnetic microparticle (dark circle) is transported above 5 micron cobalt disks (white circle). The particle moves from left to right across the center magnet as a rotating 60 Oe external magnetic field is generated with electromagnets with orientation of a. θ=180°, b. 270°, c. 0°, and d. 90° in the xz-plane. Bottom row: Profile of the magnetic field generated at the surface of the three permanent magnets delineated with the rectangle in FIG. 3A as the external magnetic field is rotated from e. θ=180°, f. 270°, g. 0°, and h. 90°. The position of the field maximum is indicated with black circle.

FIG. 4 is a schematic illustrating use of an optical detector and magnetophoretic separator to identify double magnetic particle complexes.

FIG. 5 shows a cross-sectional schematic of the magnetophoretic separator. A nozzle is provided in the separator to introduce the magnetic particles into a narrow region at the center of the carrier flow.

FIG. 6 shows mobility of 1.0 (⋄) and 2.7 micron (□) diameter superparamagnetic beads as a function of the frequency of rotation of the external magnetic field. The cumulative distribution function (CDF) and derivative of the CDF are presented as dashed and solid lines, respectively.

FIG. 7 shows velocity of superparamagnetic beads functionalized with antibodies (□—1.0 and ⋄—2.7 μm diameter) and the corresponding beads bound to B. globigii (▪) and S. cerevisiae (♦) as a function of the frequency of the external magnetic field

FIG. 8. Panel A shows an image of six bare magnetic beads and a single magnetic particle bound to B. globigii. Panel B demonstrates identification of B. globigii on the micromagnet array by adjusting the frequency of the external magnetic field to the critical value for this experimental setup.

### DETAILED DESCRIPTION OF THE INVENTION

Nonlinear magnetophoresis is a new separation technology capable of sorting through magnetic microparticles with high-resolution based on their hydrodynamic size and/or magnetic moment. In nonlinear magnetophoresis, particles with bound analyte are separated from bare particles by their magnetization-to-volume ratio in a traveling magnetic field wave created by applying a rotating magnetic field to an array of micro-magnets patterned on a substrate. Microparticles that are not bound to the analyte (i.e., have a large magnetic moment or small hydrodynamic radius) will move rapidly across the micro-magnetic array at high frequencies, while microparticles that are bound to the analyte (i.e., have a small magnetic moment or large hydrodynamic radius) are trapped on individual micromagnets until the frequency is decreased to a critical value. The amount of analyte bound to magnetic particles can be determined by simply counting the number of magnetic microparticles on the micro-magnetic array after the frequency of the magnetic field has been scanned from a high to a low frequency. Alternatively, the fraction of particles moving off the micro-magnetic array can be collected and analyzed as a function of frequency.

Thus, a bioseparation method of the present invention comprises: (i) contacting a plurality of magnetic microparticles with a fluid sample containing a target biological analyte under conditions effective to immobilize the analyte on at least one of the magnetic microparticles; (ii) providing the plurality of magnetic microparticles, upon which at least one has analyte immobilized thereon, adjacent to an array of micromagnets patterned on a substrate; and (iii) applying an external traveling magnetic field to the magnetic microparticles and array of micromagnets, so that a magnetic microparticle bound to the biological analyte moves at a different rate than an unbound magnetic microparticle, relative to the micromagnet array. Separation of the at least one biological analyte from the other biological substances in the fluid sample is thereby effected. A preferred biological analyte is a macromolecule, cell, virus, bacterium, fungal spore, or other pathogen. A particularly preferred biological analyte is one that binds specifically to magnetic microparticles that have been coated with antibody immunospecific for the analyte, e.g., bacteria.

The magnetic nano/microparticles for use with the present invention can be prepared by the method described in U.S. Ser. No. 11/552,324 (U.S. Pub. No. 2007/0172426), the disclosure of which is incorporated herein by reference. Magnetic particles prepared by this method can have a rather large size range. In particular, the particles typically have a size of between 0.01 and 10 microns. A particularly preferred size range for the microparticles is about 0.1 microns to about 10 microns. The particles comprise a paramagnetic core and a polymeric shell, with the paramagnetic core comprising at least 70% of the weight of the particle. Particles prepared according to this method have a preferred coefficient of size variance of less than 40%. For convenience, particles referred to herein as being in the “micro” size range can also be in the “nano” size range (i.e., <1 micron).

In a preferred embodiment, an aforementioned magnetic particle is functionalized so as to facilitate immobilization of a selected biological analyte on the surface of the particle. For instance, coating of the particle with Protein A enhances the ability of the particle to bind to immunoglobulins in a fluid sample, e.g., blood, sera, etc. Similarly, an immunoglobulin (Ig) or fragment thereof can be chemically attached to the particles, which imparts to the particles an ability to selectively bind to antigens having immunospecific binding affinity for the Ig. An example of the latter type of functionalization is provided in U.S. Ser. No. 11/552,324. Additional conditions, other than functionalization, that may be employed to effect immobilization of an analyte on a magnetic particle of the present invention include temperature, density, pH, and ionic strength.

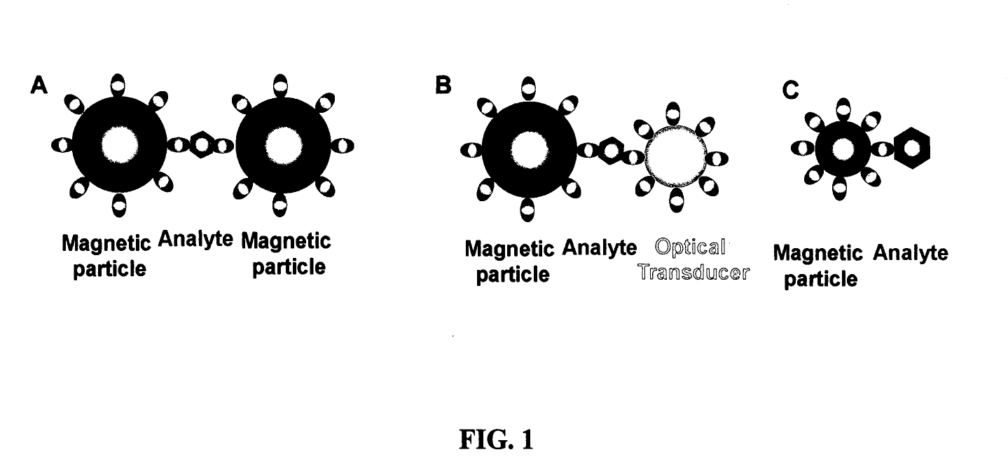

A plurality of magnetic particles is provided adjacent a micromagnet array, whereby the particles are attracted to the magnets. The particles can be provided by passing a stream of the fluid sample over the micromagnet array. Preconcentration of the particles is found to enhance the assembly of preferred double microparticle-analyte particles (see FIG. 1A).

The external traveling magnetic field applied to the magnetic microparticles adjacent the micromagnets is preferably generated with a rotating magnetic field. Generally, a separation of particles is conducted by applying the magnetic field initially at high frequency, followed by lowering the frequency so long as it remains above a critical frequency, below which microparticles bound to analyte would be moved between micromagnets.

Following separation/isolation of a desired analyte from other biological substances in the fluid sample, the analyte can be characterized by any of numerous methods, including spectroscopy, RT-PCR, ELISA, etc., as appropriate for the analyte.

In a further aspect of the invention, a system for performing nonlinear magnetophoresis of biological substances in a fluid sample is contemplated. Such a system comprises (i) a fluid container provided with an array of micromagnets on a surface of the container; (ii) inlet means through which the fluid sample can be provided internal the container; (iii) magnetic microparticles capable of specific binding to an analyte in the fluid sample; and (iv) a device capable of generating a traveling magnetic field proximate the array of micromagnets, whereby the magnetic field is effective to move the microparticles from one micromagnet to another. Such a system can further comprise mixing means external the container for preconcentrating the magnetic microparticles with the fluid sample in order to facilitate preferred double particle formation. A system may further comprise an optical detection system capable of detecting magnetic microparticles bound to analyte.

The present invention is described in greater detail herein below with reference to the drawings, particular physical properties, and application examples.

### Physical Properties of the Invention

Referring first to the particles used in the present invention, it should initially be appreciated that micron size superparamagnetic particles may be employed in cell separation and molecular diagnostics. In separation and diagnostic technologies it is desirable to use particles that can be rapidly separated, have a large surface area/volume ratio, and a uniform surface chemistry. The velocity at which a particle moves in any field at steady state (v) is determined by the Einstein-Smoluchowski formula

$$v = \frac{F}{ξ} \qquad ( 1 )$$

where F is the magnetic force applied to the particle and ξ is the frictional resistance of the particle, which is 6πμR for a solution of viscosity μ and a particle of radius R. The force applied to the particle by an external magnetic field (B) is:

\vec{F}=1/2μ₀ χ̅V∇\vec{H}² (2)

where μ₀ is the magnetic permeability of free space, χ̅ the effective susceptibility for a bead with spherical shape, V is the bead's volume, and H̅ is the field at the center of the bead.

During separation, the motion of magnetic microparticles is also influenced by gravitational, hydrodynamic, thermal, and magnetic forces. For magnetic separation to be efficient, it can be seen from Equations (1) and (2) that the particle needs to be highly magnetic and have a certain volume. However, large particles that are dense tend to settle out of an aqueous solution quickly. It has been found that micron sized particles with a magnetization >10 emu/gm are stable in solution and can be separated from an analyte in several minutes with a reasonably sized permanent magnet.

In linear magnetophoretic separation and detection, particles flow at a velocity vₕ(x,y) in the horizontal x-direction due to hydrodynamic shear. If a magnet is placed under the chamber, the particles move with a velocity vm(x,y) in the y-direction. Thus different sized particles can be separated according to their size as vₘ is proportional to the size of the particle. The resolution of magnetophoretic separation is determined by at least five factors: 1) the manner in which the particles are introduced into the flow chamber, 2) the velocity of the carrier fluid, 3) the thickness of the flow chamber, 4) the strength of the magnetic field, and 5) the size of the particles to be separated. A recent study has shown that magnetic particle-fluorescent particle complexes can be used to detect dengue virus at <10 particle forming units/ml directly from serum. However, it has been found that in practice high resolution separation is impeded by the propensity of superparamagnetic particles to interact with each other over a long range and form linear chains.

An advantage of nonlinear magnetophoresis detection over previous methods is that it is very high resolution and rapidly produces a signal in the form of a shift in mobility of the particles from a simple two step assay. The fact that the particles are separated on a micro-magnet array means that particle-particle interactions are minimized and very little carrier fluid is used. This assay could in turn be followed with a secondary assay, such as RT-PCR, that should have near single molecule sensitivity on the highly purified sample. The result is a rapid, ultrasensitive, highly selective, and inexpensive assay that can also be easily multiplexed to simultaneously detect multiple pathogens

### Magnetic Particle-Analyte Assemblies

There are at least three classes of biological analyte that can be detected with nonlinear magnetophoresis: macromolecules, such as, an entro-toxins, hormones, or proteins, that are nanometer in size and may have 1 or more epitopes per molecule; viruses that are tens of nanometers in size and typically have multiple copies of a coat protein epitope; and bacteria which are microns in size and have many copies of a repeating epitope on their coat proteins. The mode of detection that is used to identify an analyte will be determined by at least five variables: the size of the analyte, the number of epitopes that are available on the analyte, the concentration range over which the analyte will be studied, the medium from which the analyte will be extracted, and number of analytes that are to be analyzed simultaneously.

FIG. 1 presents the three magnetic particle assemblies that can be detected using nonlinear magnetophoresis. In the first assembly (FIG. 1A) the analyte is sandwiched between two magnetic particles that have been coated with receptors (e.g., monoclonal or polyclonal antibodies). The advantage of detecting magnetic particle assemblies is that their magnetic moment and hydrodynamic drag are significantly different from a monomeric particle. The formation of this type of assembly requires that the analyte have at least 2 epitopes and the reaction between the analyte and magnetic particles be driven to completion. The reaction of pathogens with microparticles is limited by the rate of diffusion of the pathogen to the particle surface as the antibody-antigen reaction rate is quite rapid. Microparticle-microparticle interactions are more infrequent than pathogen-particle interactions because the diffusion coefficient of the particles is up to 4 orders of magnitude smaller than that of the pathogens, and hydrodynamics inhibit particle-particle interactions. These two effects make the formation of double-particle assemblies a fairly infrequent event in freely diffusing particle suspensions. Fortunately, magnetic preconcentration of the magnetic particles before separation will drive this reaction to completion.

It is possible that higher order magnetic assemblies can also be formed. The exact number of magnetic particles assembled is determined by the size of the analyte, i.e., large analytes results in assemblies with larger number of magnetic particles, and the concentration of analyte, i.e., high concentration of analyte leads to assemblies produced by multiple analytes. The formation of higher order structures is not a problem as long as they can be detected either through a shift in their nonlinear magnetophoretic mobility or using some other means.

Magnetic particles can also be reacted with the analyte and nonmagnetic microparticles forming a complex illustrated in FIG. 1B. These assemblies are also easily detected using nonlinear magnetophoresis because their hydrodynamic drag is significantly different from a monomeric particle. It is also possible to use optically active nonmagnetic particles to multiplex sensing. The formation of this type of assembly requires that the analyte have at least 2 epitopes and the analyte be relatively small compared to the magnetic particle. One drawback of this detection scheme is that the formation of magnetic particle-analyte-nonmagnetic particles assemblies cannot be driven to completion, i.e., magnetic particle-analyte-magnetic particle, nonmagnetic particle-analyte-nonmagnetic particles, and nonmagnetic particle-analyte assemblies will always be formed in high concentrations.

Single magnetic particle-analyte assemblies, as shown in FIG. 1C, can be formed if only one epitope exists on the analyte or the magnetic microparticle reaction is not complete. This configuration is most likely used for macromolecular analytes that are quite small or to occur under non-ideal reaction conditions where crosslinking of magnetic microparticles is not completed. These assemblies will be difficult to detect because their magnetic moment and hydrodynamic drag are similar to a monomer. This limitation requires that the size of the superparamagnetic microparticle and micro-magnets be as small as possible.

### Preconcentration Step

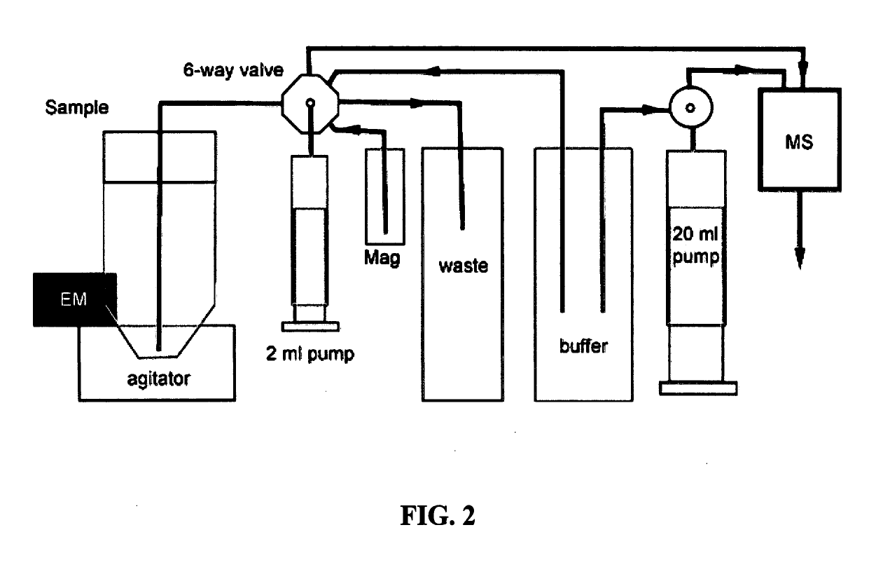

Preconcentration of the magnetic particles before they are introduced onto the micro-magnetic array can be used to drive the microparticles into the two-particle configuration (FIG. 1A), remove unwanted material from the sample matrix (e.g., cells from whole blood), or concentrate the magnetic particles so that they can be reacted at a higher concentration with nonmagnetic particles. The specific manner in which the particles are collected can be manipulated to control the assembly of the magnetic microparticles and nonmagnetic particles. In addition, chemical or processing steps (e.g., ultrasonic disruption) can be used to control the assembly of the microparticles. FIG. 2 presents a schematic of a fluidics and magnetic system that can be used to execute magnetic preconcentration.

### Principle of Nonlinear Magnetophoretic Separation

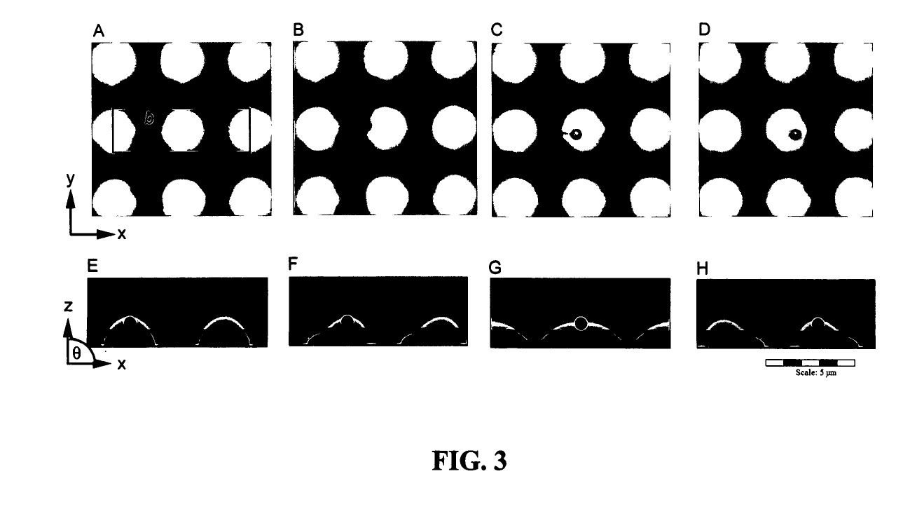

FIG. 3 illustrates the basic principle of nonlinear magnetophoretic transport, in which a superparamagnetic bead is moving across an array of micro-magnets, each of which is magnetized in the x-direction, due to action by an external magnetic field rotating in xz-plane. FIGS. 3A-D are reflected light images of a superparamagnetic microparticle (labeled b) that is moved between a 3×3 array of circular cobalt magnets, which are observed as white circles, as the direction, θ, of a spatially uniform external magnetic field is rotated in the xz-plane. In nonlinear magnetophoresis the total field includes the field produced by the substrate, nearby beads, as well as the externally applied field. In a static field, the particle will be driven to the point where the horizontal force is minimized, which is the point where H̅ is maximized.

FIGS. 3E-H present the results of finite element simulation of the total magnetic field at various locations above the surface of three permanent magnets, as θ is rotated in the xz-plane. The region of local magnetic field maxima above the thin inert glass barrier is illustrated in these figures by a 1 micron black circle. The predicted position of the magnetic field maxima is in excellent agreement with the observed position of the microparticle in the corresponding optical images.

Transport of the beads between the magnets is determined by the frequency of rotation of the external magnetic field and an inherent critical frequency, which is characteristic of the physical properties of the system. This behavior is well described by the equation of motion for the bead experiencing periodic forcing due to movement through a periodic potential produced by a traveling magnetic field wave. For low Reynold's number flow, the inertial term of the microparticle can be ignored, and the equation of motion takes the form of a non-linear oscillator:

$$\frac{d φ}{d τ} = sin ( φ ) - \frac{ω}{{ω}_{c}} \qquad ( 3 )$$

where φ is the relative phase (denoting the difference between the particle's position with respect to the orientation of the external field), ω is the driving frequency of the external rotating field, ω_{c} is the critical frequency of the particle, and τ is dimensionless time ω_{c}t.

If the damping of the bead's motion is assumed to result from hydrodynamic drag and the drag coefficient is D=6πηa, where a is the radius of a sphere moving through a fluid of viscosity η, then the critical frequency is

$${ω}_{c} = \frac{\overline{ϰ} {μ}_{0} {σ}_{0} {H}_{ext}}{18 η} {( πβ )}^{2} exp ( - πβ ) \qquad ( 4 )$$

where σ₀ is a parameter characteristic of the effective magnetic pole distribution on the array, Hₑₓₜ, is the magnitude of the external magnetic field, and β=a/d is the dimensionless ratio of the particle radius to the diameter of the magnet.

Non-linear oscillators are dynamic systems exhibiting two distinct forms of motion depending on the magnitude of the external driving frequency. When the external driving frequency is less than a critical threshold, the bead reaches a stable point in which

$$\frac{d φ}{d t} = 0 ,$$

causing the bead to become phase-locked with respect to the traveling wave and move at a constant linear velocity along the substrate with a speed equal to

$$ω \frac{d}{π} .$$

In this linear regime, the bead physically lags behind the field maximum by a distance equal to

$$Δ x = ( \frac{d}{π} ) {sin}^{- 1} ( \frac{ω}{{ω}_{c}} ) .$$

At the critical threshold, the bead will lag behind the local field maximum of the traveling wave by a distance of exactly

$$Δ x = \frac{d}{2}$$

(corresponding to a relative location that is 90° out of phase with respect to the local field maximum). Above this critical threshold, the stable and unstable solutions converge to form a saddle-nose bifurcation, which causes the bead to slip with respect to the traveling wave. Physically, the bead begins to experience an oscillatory rocking motion between adjacent magnets superimposed on a time-averaged velocity, which reduces to zero with increasing frequency at a rate defined by

$$\overline{v} = ( ω - \sqrt{{ω}^{2} - {ω}_{c}^{2}} ) \frac{d}{π} .$$

The critical frequency is proportional to the moment of the label (which is proportional to the volume of the label), and inversely proportional to the drag on the label (which is proportional to the diameter of the label). This phenomenon allows a collection of labels, which may be polydisperse in size or magnetic/hydrodynamic properties, to be selectively separated by scanning the frequency from high to low. The largest labels will move off the chip at high frequencies, whereas the smaller labels will move off the chip at lower frequencies. This concept may also be used to differentiate between labels that are identical in every aspect, except that one of the labels is attached to a biological species which produces a change in its drag factor. For example, when bacteria are attached to one of the magnet particles, such as the 1-μm sized Bacillus Globigii, it produces an appreciable change in the overall diameter of the magnetic particle—BG complex, and reduces the frequency at which the particle is mobile. This technique works best when the magnetic label is the same size or smaller than the BG, because the attachment of BG to the label produces the largest change in its drag factor.

### Sensing Biological Species

An objective of the present invention is a sensing device for use in determining the presence of the target biological species. The sensing device will discriminate the presence of target biological species from background noise by exploiting the transporting mechanism suggested above in order to bring only the target biological species to within range of the sensing device. This sensing protocol is made possible because the unattached labels are separated from the labels which are attached to bacteria prior to the sensing step. Therefore, all beads which are transported to the sensor will be carrying the target biological species.

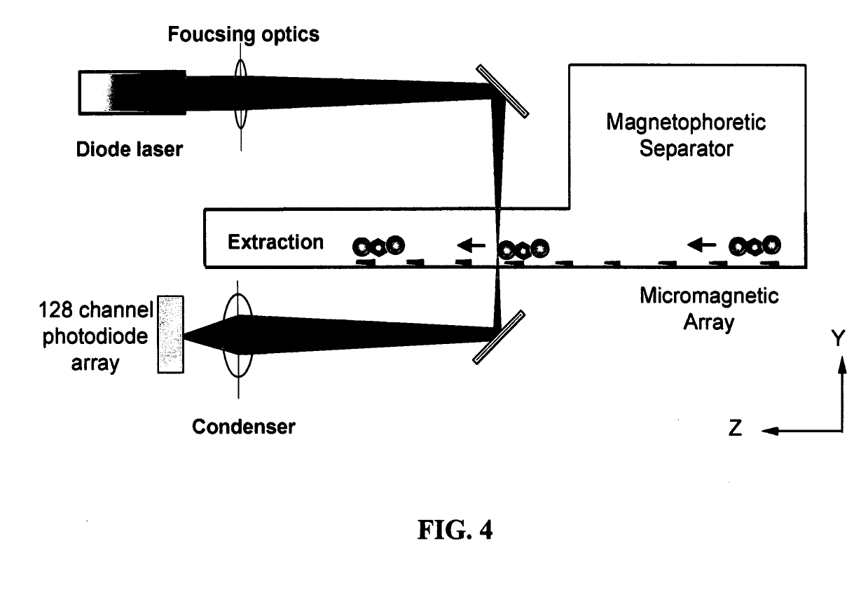

The sensor may comprise devices that sense changes in optical field, capacitance, conductance, or magnetic field. FIG. 4 illustrates an optical detector that could be used to measure the mobility of the microparticles as a function of the frequency of an alternating magnetic field on a micro-magnetic array. Sensors could also be microfabricated into the micro-magnetic array (including magnetoresistive devices, Hall sensors, magneto-impedance based sensors, and electrodes which can be used to detect changes in the capacitance or conductivity of the fluid). Using the transport mechanism described above, only the magnetically labeled complexes remain on the chip, and thus when the complexes are transported to the sensor, the change in the sensor's signal provides higher specificity that the target biological species are present in the fluid.

### Design of the Magnet Array and Magnet Assembly

In this work, the magnetically susceptible elements may take the form of, but are not limited to, an array of micron- or sub-micron sized ferromagnets. These magnetically susceptible elements may be patterned on a flat surface, or on surfaces which have more complicated morphology, such as multiple levels. Such patterning is illustrated in B. Yellen et al., PNAS, 102:8860 (2005).

The transport mechanism is accomplished by applying an electromagnetic field rotating in the x-z plane, where z—is the direction normal to the substrate. Linear transport is accomplished by combining the static fields of the magnetically susceptible elements with an externally applied rotating field in order to create a traveling wave of electromagnetic field. The labeled particles respond to this field configuration by moving in the direction of the traveling wave.

A theoretical analysis of nonlinear magnetophoresis as described hereinabove assumes that a particle does not adhere to the micromagnet array. This assumption is only valid if the microparticle-surface forces in the liquid are substantially repulsive. Surface forces in aqueous conditions are known to arise from van der Waals, electric double layer, steric, and strong short-range interactions, e.g., hydrogen bonding. We have observed that surfaces coated with casein minimize the influence of particle-surface interactions on particle transport. Casein is commonly used in biotechnology as a blocking agent to minimize protein adsorption on surfaces. Our previous studies suggest that casein adsorbs on surfaces strongly and produces long-range repulsive steric forces. Similar effects can be obtained by coating the micromagnet array with hydrophilic polymer films composed of natural polymers or synthetic polymers, such as polyethylene glycol and dextran. Other polymer films suitable for use as described hereinabove are readily apparent to one skilled in the art.

### Assembly of the Microparticles on the Micromagnet Array

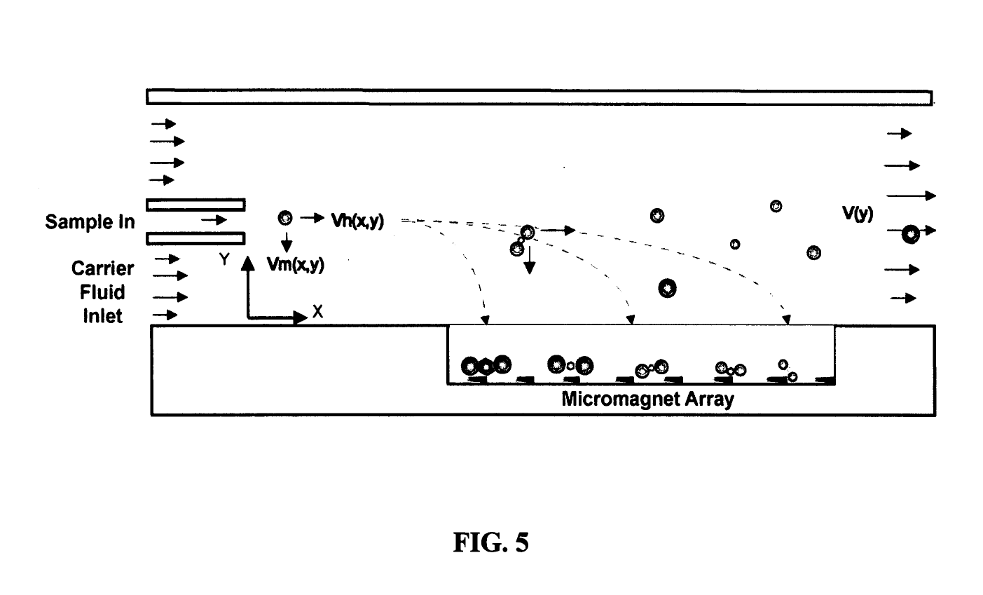

Efficient separation of the microparticles on the micro-magnetic array can be impeded by the spontaneous formation of microparticle assemblies. These assemblies result from the collision of microparticles on the micro-magnet array. Microparticle assemblies can be avoided by distributing the microparticles over the entire micro-magnet array and ensuring the density of microparticles is low enough that magnetic particle collisions is highly improbable. FIG. 5 presents a magnetophoretic separator that combines linear and nonlinear magnetophoretic separation schemes to ensure an even distribution of microparticles over the micro-magnet array. Similarly, hydrodynamic or electrodynamics forces can be used to sort the particles either before they reach the micromagnet array or during the nonlinear magnetophoretic separation process.

Reference is now made to specific examples using the processes and principles described above. These examples are provided simply to more completely describe preferred embodiments, and no limitation to the scope of the invention is intended thereby. Alterations and modifications of the present invention, and further applications of the principles of the invention as illustrated herein, are readily within the capacity of the skilled practitioner.

### EXAMPLES

The magnetic particles used in the Examples were prepared by the emulsion template technique described in U.S. Ser. No. 11/552,324, the disclosure of which is incorporated herein by reference.

### Example 1

### Construction of Micro-Magnet Array

The micro-magnet arrays were produced by a conventional photolithographic liftoff process. This technique was used to fabricate 5-μm diameter, 70 nm thick cobalt micro-magnets that were equally spaced in a square array with center to center distance of 8 μm. These magnets were coated with a micron thick layer of spin-on glass. The glass layer was then coated with a layer of casein, which is a milk protein, to minimize the adhesion of the microparticles with the spin-on glass layer.

Calculations suggest that the thickness of the spin-on glass layer is not optimized at one micron. Further refinement of the thickness of the layer is within the skill of the practitioner. A further consideration is the type of coating applied to the glass layer. The coating must be one that does not adhere to the magnetic particles, neither those particles bearing a target analyte or those free of analyte. Other coatings for the micro-magnets can include hydrophilic polymers, such as polyethylene glycol and dextran.

### Example 2

### Construction of Magnetophoretic Instrument

The rotating field was produced by two pairs of air-core solenoids fitted with cast iron cores, which were arranged along mutually orthogonal axes (x-z) with respect to the wafer surface. Two current sources controlled by Labview software (National Instruments, Austin, Tex.) were used to supply sinusoidal waveforms to each pair of solenoid coils, adjusted with 90° phase difference in order to generate rotating magnetic field. Magnetic beads were injected onto the wafer surface in a 10-μm thick fluid layer, and the separation process was observed through a Leica DMLM microscope in a 40× or 100× objective.

### Example 3

### Microparticles and Surface Chemistries

MyOne™ and M-270™ superparamagnetic beads were purchased from Dynal Biotech (Madison, Wis.) due to the uniformity of the particle size. These beads are reported to be loaded with 37% and 20% ferrites by volume, respectively. The beads were acquired with carboxyl or streptavidin surface coatings. The B. globigii and polyclonal antibodies against B. globigii were a kind gift of Jennifer Aldrich and Thomas O'Brien (Tetracore, LLC, Rockville, Md.). These antibodies were biotinylated by reaction in a 1:20 molar ratio with sulfosuccinimidobiotin (Pierce, Rockford, Ill.) in a 12 mM phosphate buffered saline, 150 mM NaCl, pH 7.4, for 30 minutes. Excess biotin was removed by passing the solution through cellulose desalting column (Pierce). The S. cerevisiae (i.e. baker's yeast) was obtained from Sigma-Aldrich (St. Louis, Mo.) and the biotinylated concanavalin A (con A) was obtained from Biomeda (Foster City, Calif.). The 1-μm streptavidin functionalized beads were functionalized with antibodies against B. globigii by reacting 10⁶ beads/ml with 0.1 mg/ml of antibody solution in 50 mM Na2HPO4/NaH2PO4, 150 m M NaCl buffer (PBS) with 0.01% Tween-20™. The 2.7-μm streptavidin functionalized beads were functionalized with con A by reacting 10⁶ beads/ml with 0.1 mg/ml of protein solution in sodium acetate buffer pH 6.5, 0.9% NaCl containing 1 mM Ca²⁺ and Mn²⁺ ions and 2-5 mg/mL bovine serum albumin.

### Example 4

### Separation of Magnetic Particles of Different Size

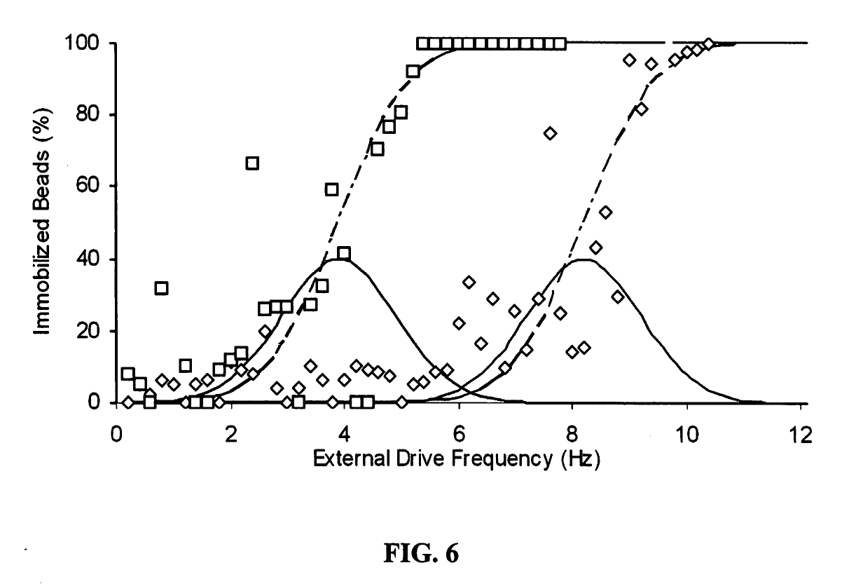

Non-linear magnetophoresis can be used to separate beads based on size if the driving frequency of the external magnetic field is scanned from high to low. To demonstrate this principle, the mobilities of 1.0 and 2.7 μm diameter superparamagnetic beads were tracked as a function of the external driving frequency between 0 and 15 Hz in 0.2 Hz intervals. FIG. 6 shows the percentage of immobilized beads as a function of the external driving frequency. Nearly all the beads are transported at the lower frequencies; whereas at frequencies significantly above the critical threshold the beads are uniformly immobilized. Least squares fitting of the first derivative of the cumulative distribution function (solid lines in FIG. 6) indicated that the critical frequency of the 1.0 and 2.7-μm beads was 3.8±0.3 and 8.2±0.49 Hz, respectively. The critical frequency predicted by Equation 7 for the 1.0 and 2.7-μm beads is 3.8 and 8.3 Hz, respectively, when σₒ≈30 Oe, the external field has magnitude of 60 Oe, the nominal viscosity near the wall is assumed to be three times that of bulk water, and the magnetic susceptibilities of the 1.0 and 2.7 μM beads are 0.30 and 0.17, respectively. Hence, the transport behavior of the magnetic beads appears to be in reasonable agreement with the simplified model that has been developed for non-linear magnetophoresis.

Analysis of errors indicates that the critical frequency distribution primarily resulted from the variation in the magnetic content of the beads, indicating that the resolution of non-linear magnetophoretic separation technique is currently limited by variations in the magnetic moments of the supplied beads. New superparamagnetic beads composed of densely packed magnetite nanoparticles promise to reduce the variation in the magnetization within a lot of beads to less than 2% of the mean value.

### Example 5

### Identification of B. globigii and S. cerevisiae

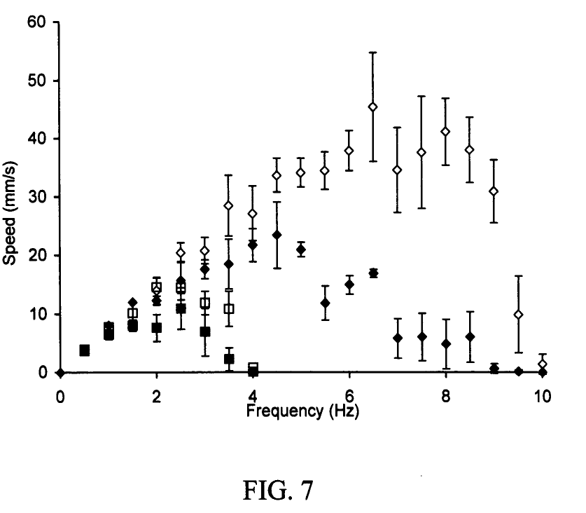

Non-linear magnetophoresis has been applied to separate and identify several microorganisms that were chosen as models for pathogens. B. globigii and S. cerevisiae were attached to 1.0 and 2.7 μm diameter superparamagnetic beads, respectively, by reaction with beads that were coated with appropriate affinity receptors. The magnetophoretic behavior of the bead-microorganism complexes were characterized by measuring their velocities, and the results shown in FIG. 7 are provided as a function of external driving frequency between 0 and 10 Hz in 0.5 Hz intervals. The B. globigii, having an average diameter of approximately 500 nm, changed the effective hydrodynamic drag coefficient of the 1.0 μm bead by approximately 10%, and causes the critical frequency of the beads carrying the bacteria to be lowered by approximately 0.5 Hz compared to the unbound bead. This decrease in critical frequency is consistent with an increase in the hydrodynamic drag of the complexed bead although the interaction of the complex with the surface of the microarray may also result in increased drag. Although the bandwidth of this experimental setup is not high, a driving frequency of approximately 3.5 Hz produced an average velocity of the bare beads that is almost an order of magnitude faster than the average velocity of the bead-B. globigii complex. A more pronounced result was obtained when analyzing the velocity of single 2.7 μm beads attached to single S. cerevisiae as the size of the bead is more closely matched both to the micromagnet size and to the average diameter of S. cerevisiae, which is around 5 μm on average. The critical frequency of the bead-yeast complex is several Hz lower than the bare bead, and a driving frequency of 9.0 Hz produces an average velocity of the bare beads that was nearly two orders of magnitude faster than the average velocity of the bead-yeast complexes.

The resolution of the non-linear magnetophoretic process is determined by the properties of the particle, micro-magnets, external field, and the number of magnetic steps used to separate the beads. The advantage of this technique is that small differences in critical frequency can be used to efficiently separate particles by great distances due to the large number of micro-magnets in an array.

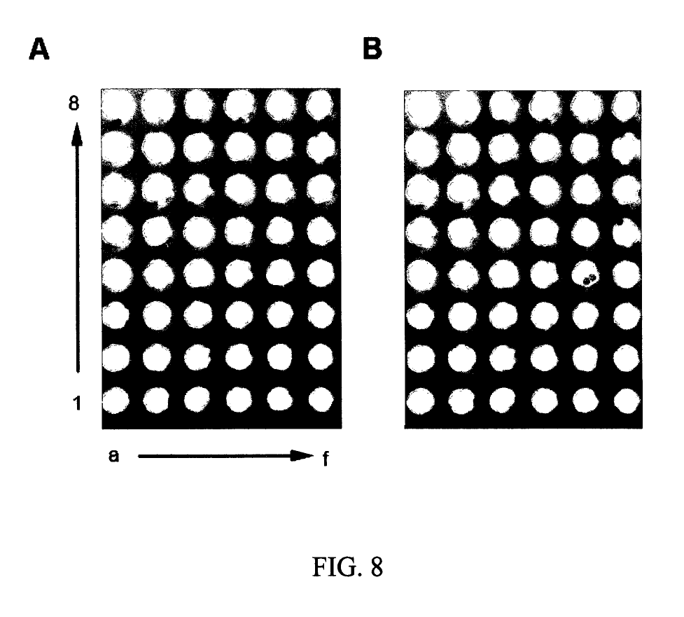

FIGS. 8A and 8B demonstrate the separation of a particle complexed with B. globigii from uncomplexed beads. A typical magnetic particle distribution on the microarray after the injection of the microparticle solution is presented in FIG. 8A. A single particle complexed with B. globigii is observed on magnet 4e along with 6 uncomplexed beads. FIG. 8B presents the results of application of the external magnetic field to the chip at 3.5 Hz for several thousand cycles. The microparticle complexed with B. globigii does not move but the original uncomplexed beads have been removed from the chip. In fact, most of the uncomplexed beads are removed from this area of the chip, although a single uncomplexed particle is seen to have moved onto the array at magnet 5f.

### Example 6

### Other Applications

Superparamagnetic particles can be functionalized with antibodies against a specific cell type, the particles can be reacted with the sample, and nonlinear magnetophoresis can be performed to separate out the particles that are bound to the specific cell type. The advantage of using this technique over conventional magnetic separation is that the magnetic particles are not compacted into a pellet and thus the cells are less likely to be stressed by crosslinking to multiple particles or force. It should be understood that the magnetic particles do not have to be functionalized with antibodies but can be functionalized with hydrophobic or other groups. This would allow other forms of chromatography to be performed.

### CONCLUSION

Multiplexed nonlinear magnetophoretic identification has been demonstrated for superparamagnetic microparticles 1 and 2.5 microns in diameter that have been bound to B. globigii or S. cerevisiae using monoclonal antibodies. Desirable features of nonlinear magnetophoretic detection include: rapid rates of reaction through the use of microparticles; near single organism sensitivity through magnetic separation, magnetic concentration, and single particle detection; rapid response times through magnetic concentration, magnetic separation, and the elimination of several time consuming and expensive biochemical processing steps. Moreover, after magnetic separation is completed, secondary assays such as PCR or electrochemiluminescence can be conducted on the isolated pathogens to provide additional information about the pathogen or its state. The use of nonlinear magnetophoresis as a separation technique will greatly enhance the reliability of these assays. The present technology can be fully scalable if large arrays of micromagnets are used, which would be advantageous to permit recycling of unbound particles.

The present invention has been described with reference to particular examples for purposes of clarity and understanding. It should be appreciated that certain modifications and improvements can be practiced within the scope of the appended claims and their equivalents.

What is claimed is:

1. A method of separating at least one biological analyte from other biological substances in a fluid sample comprising:
(i) contacting a plurality of magnetic microparticles with the sample under conditions effective to immobilize the biological analyte on at least one of the magnetic microparticles;
(ii) providing the plurality of magnetic microparticles, at least one of which having biological analyte immobilized thereon, adjacent to an array of micromagnets patterned on a substrate; and
(iii) applying an external traveling magnetic field to the magnetic microparticles and array of micromagnets, so that a magnetic microparticle bound to the biological analyte moves at a different rate than an unbound magnetic microparticle, relative to the micromagnet array, thereby affording separation of the at least one biological analyte from the other biological substances in the fluid sample.

2. The method of claim 1, wherein the at least one biological analyte is a macromolecule, cell, virus, bacterium, fungal spore, or other pathogen.

3. The method of claim 1, wherein the magnetic microparticles are coated with an antibody immunospecific for the biological analyte.

4. The method of claim 1, wherein the magnetic microparticles have a diameter in the range of about 0.1 microns to about 10 microns.

5. The method of claim 1, wherein said effective conditions include temperature, density, pH, and ionic strength.

6. The method of claim 1, wherein the magnetic particles and biological analyte are provided adjacent the micromagnet array by passing the fluid sample over the micromagnet array.

7. The method of claim 1, wherein the external traveling magnetic field is generated by a rotating magnetic field.

8. The method of claim 1, wherein the magnetic microparticle and at least one analyte are additionally bound to an optical transducer or second magnetic microparticle.

9. The method of claim 1, further comprising characterizing the separated at least one biological analyte immobilized on the magnetic microparticle.

10. A system for performing nonlinear magnetophoresis of biological substances in a fluid sample, comprising: (i) a fluid container provided with an array of micromagnets on a surface of the container; (ii) inlet means through which the fluid sample can be provided internal the container; (iii) magnetic microparticles capable of specific binding to an analyte in the fluid sample; and (iv) a device capable of generating a traveling magnetic field proximate the array of micromagnets, which field is effective to move the microparticles from one micromagnet to another.

11. The system of claim 10, further comprising mixing means external the container for combining the magnetic microparticles with the fluid sample.

12. The system of claim 10, further comprising an optical detection system capable of detecting magnetic microparticles bound to analyte.
